(19) United States
(12) Patent Application Publication
(10) Pub. No.: US 2003/0131508 A1
(43) Pub. Date: Jul. 17, 2003

(54) Candle pillar

(76) Inventor: Paul Maritz, Langley (CA)

Correspondence Address: WAX DE-LITE LTD., 21277 78 AVE., LANGLEY, BC, V2Y 2E9, CA

(21) Appl. No.: 10/095,768

(22) Filed: Jan. 17, 2002

(51) Int. Cl. G09F 13/00

(52) U.S. Cl. 40/442

(57) ABSTRACT

In decoration at festive occasions, objects such as, candles and flowers that have a limited lifespan can only be used at one festive occasion after which they are usually not suitable for re-use. This creates a need for an object that can be re used as decoration at festive occasions and wherever else it may be suitable, that is relatively inexpensive, versatile and appealing to the eye.

In this invention there is a decorative housing having a cavity designed to receive a source of light therein and wherewith the walls of the housing are manufactured from wax, typically white.

The housing may be configured to receive a second housing at one end, so that a plurality of housings can be stacked on top of each other and may be in the shape of a pillar to be selected from a group that is spherical, rectangular, heart-shaped and star-shaped. Housings can be stacked on top of each other and one or more light sources (fluorescent or fiber optics) can be inserted into the cavities of the housing. The housing or pillar is capable of receiving a candle on an upper end of the housing.

The candle may be spherical or may have any other suitable shape, for example, cylindrical or square.

### FIELD OF INVENTION

This invention relates to a decorative housing using wax.

### BACKGROUND OF THE INVENTION

The inventor is aware of many different kinds of objects that are capable of being used as decoration at festive occasions such, for example, weddings, birthdays, year-end functions and the like.

Objects such as, for example, candles and flowers have a limited lifespan and can therefore only be used at one festive occasion after which they are usually not suitable for reuse. This makes the purchase of such objects expensive.

The inventor therefore believes, that a need exits for an object that can be used as decoration at festive occasions and wherever else it may be suitable, that is relatively inexpensive, versatile and appealing to the eye.

### SUMMARY OF THE INVENTION

Thus, according to the invention, there is provided a decorative housing including:

Walls defining the housing. The housing having a cavity diminished to receive a source of light therein and wherein the walls of the housing are manufactured from wax.

The housing may be configured to receive a second housing at one end, so that a plurality of housings can be stacked on top of each other.

The housing may be elongated in side view.

The outer surfaces of the walls of the housing may include longitudinally defined recesses.

The housing may be in the shape of a pillar.

Alternatively, the three-dimensional shape of the housing may be selected from the group including: spherical, rectangular, heart-shaped and star-shaped.

The walls of the housing may be manufactured from candle wax having any suitable color, typically white.

The walls of the housing may display patterns and I or representations.

According to a second aspect of the invention, there is a provided method of using a decorative housing as described above wherein a desired number of housings are stacked on top of each other and one or more light sources (including fiber optics) are inserted into the cavities of the housing.

The light source may be a conventional non-heat emitting light source, for example, a fluorescent lamp, or fiber optical lighting.

According to a yet further aspect of the invention there is provided a stand for a candle including:

A housing as described above wherein the housing is capable of receiving the candle on an upper end of the housing.

The candle may be spherical or may have any other suitable shape, for example, cylindrical or square.

A conventional non-heat emitting light source, for example, a fluorescent lamp or fiber optics may be inserted into the cavity of the housing in use.

### DETAILED DESCRIPTION OF THE INVENTION

The invention will now be described by the way of the following non-limiting example with reference to the accompanying drawing.

In the drawings:

FIG. 1 (Pg.12)—shows a three-dimensional view of an embodiment of a decorative housing in accordance with the present invention.

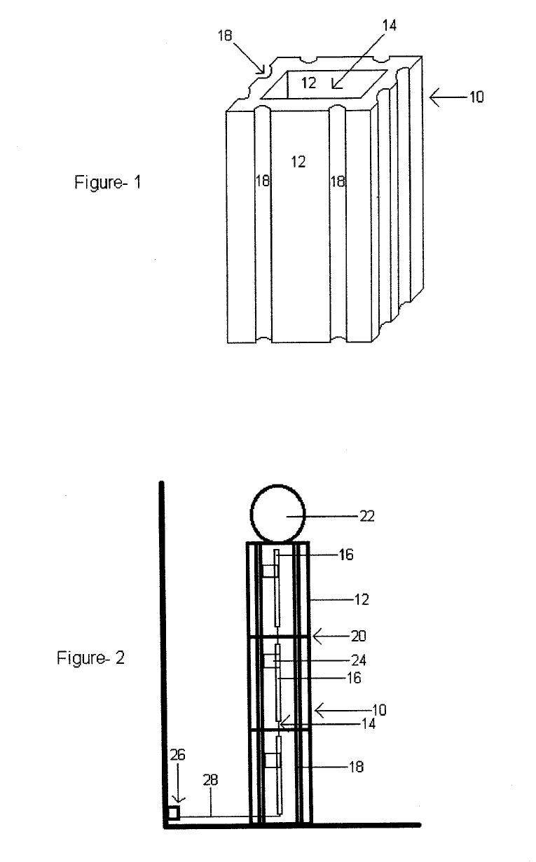

FIG. 2 (Pg.12)—shows a side view of a stand for a candle a accordance with the present invention in use.

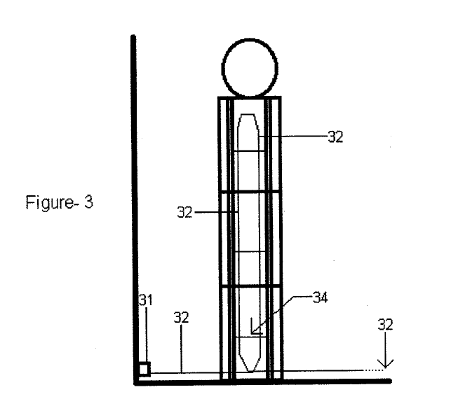

FIG. 3 (Pg. 13)—shows FIG. 2 (Pg.12) using fiber optic lighting.

### In the drawings, reference numeral 10 generally indicates a decorative housing in accordance with the present invention.

A decorative housing 10 includes walls defining the housing 10, the housing 10 having a cavity 14 dimensioned to receive a source of light 16 or 32 as shown in FIG. 2 (Pg.12) and 3 therein. The walls 12 of the housing 10 are manufactured from candle wax.

The housing 10 is configured to receive a second housing 10 at one end, so that a plurality of housings 10 can be stacked on top of each other as shown in FIG. 2. (Pg.12)

The housing 10 is elongate in side view and is in the shape of a pillar, the outer surfaces of the walls 12 including longitudinally defined recesses 18. The color of the walls 12 is typically white.

Referring now to FIG. 2 (Pg. 12) only, a stand 20 for a candle 22 including a housing 10 as described above wherein the housing 10 is capable of receiving the candle 22 on an upper end of the housing 10 is shown.

The candle 22 is typically spherical.

In use, pluralities of light sources 16 or 32 are inserted into the cavities 14 of the housings 10.

The light sources 16 and 32 are conventional non-heat emitting light sources, such as fluorescent lamps or fiber optical tubes.

The light sources 16 and 32 are secured within the cavities 14 of the housings 10 by means of brackets 24 and connected in series to an electrical power supply 26 via cable 28. The fiber optical tube is connected first to the illuminator 31 then to the power source.

It is to be appreciated, that the invention is not limited to any specific embodiment or configuration as hereinbefore generally described or illustrated.

[image]

1. A decorative housing including:
Walls defining the housing, the housing having a cavity dimensioned to receive a source of light therein and wherein the walls of the housing are manufactured from wax.

2. A housing as claimed in claim 1 wherein the housing is configured to receive a second housing at one end, so that a plurality of housings can be stacked on top of each other.

3. A housing as claimed in claim 1 or claim 2 wherein the housing is elongate in side view.

4. A housing as claimed in claim 3 wherein the outer surfaces of the walls of the housing include longitudinally defined recesses.

5. A housing as claimed in claim 3 wherein the housing is in the shape of a pillar.

6. A housing as claimed in claim 1 or claim 2 wherein the three-dimensional shape of the housing is selected from the group including: spherical, square, rectangular, heart-shaped and star-shaped.

7. A housing as claimed in any one of the preceding claims wherein the walls of the housing are manufactured from candle wax.

8. A housing as claimed in any of the preceding claims wherein the walls of the housing display patterns and/or representations.

9. A method of using a decorative housing as described in any one of claims 1 to 8 wherein a desired number of housings are stacked on top of each other and one or more light sources, including fiber optical lights, are inserted into the cavities of the housings.

10. A method as claimed in claim 9 wherein the light source is a conventional non-heat emitting light source.

11. A method as claimed in claim 10 wherein the light source is a fluorescent lamp.

12. A method as claimed in claim 10 wherein the light source is fiber optics.

13. A stand for a candle including:
A housing as claimed in any one of claims 1 to 8 wherein the housing is capable of receiving the candle on an upper end of the housing.

14. A stand as claimed in claim 13 wherein the candle is spherical.

15. A stand as claimed in claim 13 or claim 14 wherein a conventional non-heat emitting light source is inserted into the cavity of the housing in use.

16. A stand as claimed in any one of claims 13 to 15 wherein the light source is a fluorescent lamp.

17. A stand as claimed in any one of claims 13 to 15 wherein the light source is fiber optics.

18. A decorative housing according to the invention, as hereinbefore generally described.

19. A decorative housing as specifically described with reference to or as illustrated in the accompanying drawings.

20. A decorative housing including any new and inventive integer or combination of integers, substantially as herein described.
